(19) United States
(12) Patent Application Publication
(10) Pub. No.: US 2006/0193684 A1
(43) Pub. Date: Aug. 31, 2006

(54) SAFETY DEVICE FOR LOCKING AN ADJUSTABLE CONNECTING PIECE

(76) Inventor: Burkhard Schafer, Ganderkesee (DE)

Correspondence Address: MCGLEW & TUTTLE, PC, P.O. BOX 9227, SCARBOROUGH STATION, SCARBOROUGH, NY, 10510-9227, US

(21) Appl. No.: 11/382,195

(22) Filed: May 8, 2006

Related U.S. Application Data
(63) Continuation of application No. 10/834,309, filed on Apr. 28, 2004.
Application No. 10/834,309 is a continuation of application No. PCT/DE03/01976, filed on Jun. 12, 2003.

(30) Foreign Application Priority Data
Jun. 14, 2002 (DE) DE 102 26 769.3

(51) Int. Cl. B25G 3/24

(52) U.S. Cl. 403/290

(57) ABSTRACT

At least one mounting part (1), which has at least one passage opening (1a) for guiding a connector (3). The connector (3) cooperates with a clamping part as a spindle nut (4) and a clamping mechanism (100′). The clamping mechanism (100′) moves in a clamping direction in relation to the spindle nut (4) to clamp a connecting piece (4) to the mounting part or mounting part (1). A positioning mechanism 200 includes a yoke (11, 12) cooperating with the clamping mechanism (100) and the spindle nut (4). The positioning mechanism (200) has a passage opening (11a) in the yoke (11, 12) that is at least congruent with the passage opening (1a) of the first mounting part (1), as well as a spindle (10), which is connected with the clamping mechanism (3, 4, 7) via the spindle nut (4). The clamping mechanism (100′) applies force to the spindle pin (10) relative to the spindle nut (4) and yoke surfaces to block said spindle pin from rotating to lock a position of said spindle nut along said spindle pin.

### CROSS REFERENCE TO RELATED APPLICATION

This is a continuation of application Ser. No. 10/834,309 which is a continuation and claims the benefit (35 U.S.C. §120 and 365(c)) of copending International Application PCT/DE03/01976 of 12 Jun. 2003, which designated inter alia the United States and this International Application claims the priority of German Application DE 102 26 769.3 of 14 Jun. 2002. The entire contents of each application is hereby incorporated by reference in its entirety.

### FIELD OF THE INVENTION

The present invention pertains to a safety device for locking an adjustable connecting piece, especially a jacket tube of a steering column of a motor vehicle, with at least one mounting part, which has at least one passage opening for guiding a connector that connects at least two clamping parts that are movable in relation to one another and clamp the connecting piece, wherein the connector and the clamping parts form a first clamping mechanism, and means are provided for securing the clamping mechanism.

### BACKGROUND OF THE INVENTION

Such safety devices are used, among other things, in motor vehicles in conjunction with the adjusting means of an adjustable steering column to avoid safety hazards.

Operating elements, for example, the steering wheel, and other means of a motor vehicle (seat, mirrors) are adjustable corresponding to the passenger's individual needs because of ergonomic and safety engineering conditions. Corresponding locking or clamping devices are needed in order to prevent the setting of these operating elements, such as steering wheel or seat, from changing spontaneously during operation and thus from representing a safety hazard. Moreover, some safety elements are based on adjustable operating elements, for example, a driver's side air bag in a steering wheel, which is connected to an adjustable steering column. To guarantee the corresponding safety function of an air bag, it must be ensured that these safety elements withstand the loads that occur. Thus, a safety element, for example, an air bag, is designed such that the construction supporting it will not yield, for example, in a direct collision.

A clamping device that has a blocking element as an additional clamping mechanism is known from the patent DE 195 06 210 C1. When safety function is needed, this blocking element presses the inner surface of the connecting piece, e.g., of a jacket tube, with a sword-like edge and thus ensures a nonpositive clamping function. The sword-like edge can dig into the surface of the connecting piece under higher loads and thus additionally generate an increased clamping action.

The drawback that occurs with the prior-art clamping devices or safety devices is that in case of a frictionally clamped safety device, the high, pulse-like loads occurring during a direct collision are not absorbed reliably by the clamping device, and the position of the steering column will therefore change (so-called negative crash behavior). Even though the above-mentioned loads are absorbed in the case of a positive-locking safety device, so that the position of the steering column will not change, a continuous, individual setting is no longer possible in this case because of the division of the safety device. Moreover, a “head-to-head” position cannot be completely prevented from occurring in the case of clamping separated via teeth, which likewise leads to slipping through under a pulse-like load.

### SUMMARY OF THE INVENTION

One of the objects of the present invention is therefore to provide a device in which the continuous, individual setting of a connecting piece is guaranteed and which reliably absorbs the loads occurring in a direct collision, without a change in the position of the connecting piece, so that satisfactory function of the safety devices based on this safety function, for example, of an air bag, is ensured.

This object is accomplished on the basis of a device with a mounting part and a connecting piece arranged inside the mounting part. The connecting piece is movably mounted in the mounting part in an adjusting direction. A connector is arranged adjacent to the mounting part. The connector has a clamp mechanism and a second side clamp part. The clamp mechanism may be selectively actuated for clamping the connector to the mounting part and fixing the mounting part to the connecting piece. The second side clamp part includes a spindle nut to be locked and unlocked by clamping and unclamping of the clamp mechanism.

The present invention allows the means for locking one aspect of the position of the overall device as a positioning mechanism, which includes clamping parts cooperating with the clamping mechanism and at least a positioning device mounting part (yoke), which has a passage opening that is at least congruent with the passage opening of the first mounting part, as well as a spindle, which is connected with the clamp mechanism via a clamping part of the clamp mechanism, which clamping part is designed as a spindle nut, so that both position setting aspects can be detached or locked via the clamp mechanism.

The solution according to the present invention offers the advantage that because of the combination of the two different principles of positioning—the nonpositive clamping (from the clamp mechanism actuation) and the positive-locking positioning—the advantages of the two principles are combined and a better safety function and greater comfort for the user are thus achieved.

The first mounting part is preferably designed as a bracket provided with a U-shaped part, because a more favorable force distribution and simpler assembly are thus guaranteed, and the bracket body may be cast or shaped from sheet metal.

It is advantageous that the connector is designed as a clamping pin with a head designed as a spindle nut, because a simple clamping connection can thus be embodied.

The oblong passage opening may be designed as an elongated hole formed in the direction of adjustment, so that a guiding possibility that can be manufactured in a simple manner can be embodied.

Another advantage is that the clamp mechanism is designed as a multipart clamping mechanism with a lever, as a result of which this would be able to be used in the clamping mechanisms known from the state of the art.

Another measure improving the present invention is that the mounting part of the positioning mechanism is designed as a yoke, so that the spindle is guided axially and radially and more reliable positioning can thus be guaranteed.

The pitch of the spindle is preferably selected to be such that self-locking is achieved because of the spindle pitch selected and a safety function is thus guaranteed.

The connecting piece is preferably designed as a jacket tube with a welded-on U-shaped carrier, which has a through hole on each leg for connection with the connector designed as a connecting pin, because a simple possibility of manufacture along with improved force distribution is thus guaranteed.

The clamp mechanism can include a quick release lever mechanism, where movement of the quick release lever mechanism selectively tensions the clamping pin to clamp and unclamp. The clamp mechanism can also include a positioning device for positioning the quick release lever mechanism. The quick release lever mechanism is arranged between the mounting part and the positioning device, where rotation of the quick release lever mechanism expands and contracts the quick release lever mechanism to selectively clamp and unclamp (fix and unfix) and also lock and unlock the positioning mechanism.

The second side mechanism preferably includes a spindle pin rotatably mounted in the spindle nut to adjust a position of the spindle nut in the adjusting direction. Clamping of the clamp mechanism applies a force to the spindle pin to block the spindle pin from rotating. The positioning mechanism then preferably includes a yoke to receive the spindle pin. The spindle pin contacts the yoke to block rotation of the spindle pin and lock the second clamp when the first clamp applies force to the spindle pin. The yoke can have a wedge shaped surface contacting the spindle to block rotation of the spindle pin when the first clamp applies force to the spindle pin. The yoke is fixed to the mounting part.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is an isometric schematic view of a first mounting part according to the present invention;

FIG. 2 is an isometric schematic view of a connecting piece according to the present invention, which is designed as a jacket tube of a motor vehicle steering column;

FIG. 3 is a cross section of a schematic view of a nonpositive clamping mechanism according to the present invention without a second side clamping mechanism;

FIG. 4 is a cross section of a schematic view of a combination according to the present invention of a nonpositive clamping mechanism and a positive-locking clamping mechanism;

FIG. 5 is a section along the section line A-A in FIG. 4; and

FIG. 6 is a detail view of FIG. 4.

### DESCRIPTION OF THE PREFERRED EMBODIMENT

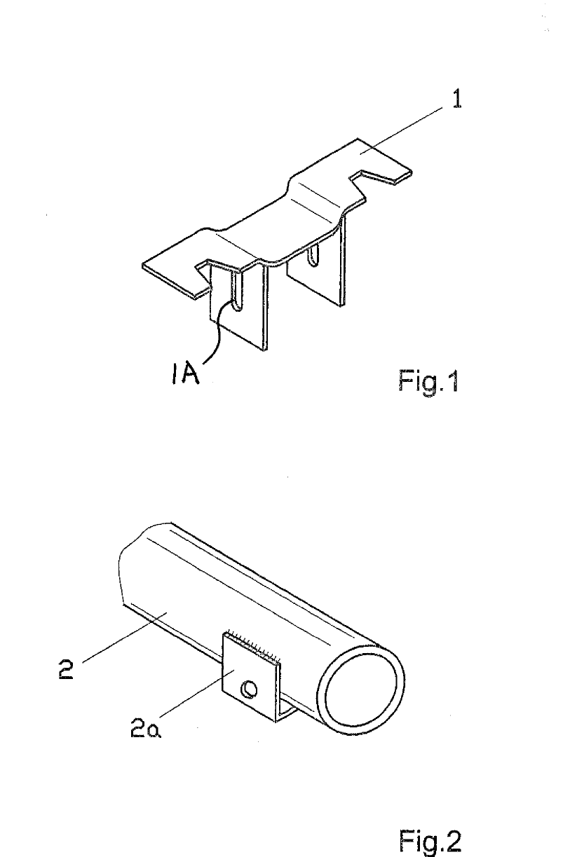

The steering column bracket body or mounting part 1 according to FIG. 1 includes portions that are U-shaped. The mounting part 1 has an elongated hole 1a per leg. This elongated hole 1a is used to guide the connector of the first clamping mechanism and guarantees an adjustment possibility. The body is bent from a sheet metal according to this embodiement.

FIG. 2 shows a fastening device 2a, which is welded to a jacket tube or connecting piece 2, which accommodates the complete steering shaft with the mount and the adjoining components (not shown), and has two holes for being accommodated between the clamping parts that providing clamping.

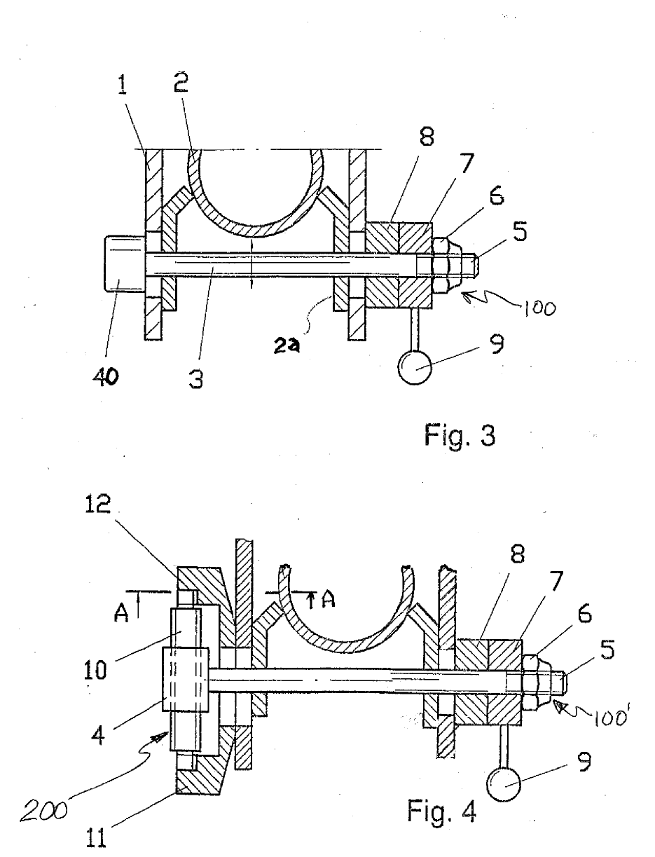

A clamping mechanism 100 according to FIG. 3 comprises a threaded section 5 on the side of a connecting pin or connector 3. This cooperates with a head 40. The clamping mechanism 100 is for setting a self-securing adjusting nut 6 with a head 40. Clamping parts 7, 8, are designed as a stepped disk, needle mechanism or thread pitch, with a lever 9, which generates a lifting movement between the clamping parts 7, 8 by pivoting around a pin axis. The pivoting releases or locks the clamping mechanism 100. The clamping parts 7, 8 are located between the right-hand leg of the fastening device 2a of the jacket tube 2 and the adjusting nut 6.

FIG. 4 shows a combination according to the present invention of a nonpositive clamping mechanism or first clamping (fixing) mechanism 100′ and a positive-locking positioning mechanism or a second clamping (fixing) mechanism 200. The clamping mechanism 100′ according to FIG. 4 cooperates with the connecting pin or connector 3 and with a head clamping part 4. The head part 4 is also part of the positioning mechanism or second clamping mechanism 200. The connector 3 is a pin 3 with a threaded section 5 on the side of the pin 3 located away from the head clamping part 4. The thread is used for setting the self-securing adjusting nut 6. The clamping parts 7, 8, are designed as a stepped disk, needle mechanism or thread pitch, with a lever 9, which generates a lifting movement between the clamping parts 7, 8 by pivoting around a pin axis. The pivoting releases or locks the clamping mechanism 100′. The clamping parts 7, 8 are located between the right-hand leg of the fastening device 2a of the jacket tube 2 and the adjusting nut 6.

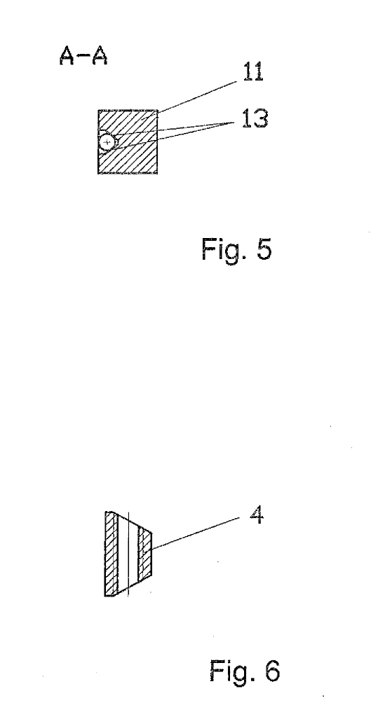

The positioning mechanism 200 is provided with a spindle pin 10 and yoke 11, 12. The positioning mechanism uses the head clamping part 4 designed as a spindle nut. The spindle pin 10 is fixed axially and radially in an upper shank 12 or lower shank 11 of the yoke based on respective surfaces 13, which can be seen more clearly, in the sectional view along line A-A of FIG. 5. The spindle pin 10 is held axially between upper and lower shanks of the yoke 12, 11 (see FIG. 4). The yoke 11, 12 prevents an axial adjustment of the spindle. Each of the shanks includes the respective yoke surface 13. The oblong opening of the yoke 11, 12 corresponds to the passage opening 1a of the steering column bracket 1 shown in FIG. 1. When the steering column is adjusted, the first clamping mechanism 100′ and consequently also the positioning mechanism 200 are opened, and thus they make possible an axial adjustment. The clamping pin 3 and head clamping part 4 moves axially (with respect to the axis of the spindle 10) during the adjustment process, and the spindle 10 rotates during this movement. The entire adjustment process can also be thought to be such that after releasing the clamping of the first clamping mechanism 100′, the spindle 10 is rotated, for example, by means of an electric motor (not shown). This rotation is transformed via the head 4 into a translation taking place in the axial direction and thus it adjusts the steering column.

FIG. 5 shows the sectional view along line A-A of FIG. 4 with the yoke 11 of the positioning mechanism 200 having a wedge surface 13 forming a radial guide. The wedge-shaped surface 13 has a tip (cone point) directed toward (facing) the U-shape part. As can be seen in FIG. 5, each yoke surface 13 forms a guide for the spindle 10 with rotation of the spindle 10 causing the clamping pin 3 and head clamping part 4 to move axially.

While specific embodiments of the invention have been shown and described in detail to illustrate the application of the principles of the invention, it will be understood that the invention may be embodied otherwise without departing from such principles.

What is claimed is:

1. A safety device for locking an adjustable connecting piece, the safety device comprising:
a mounting part defining at least one passage opening;
a connecting piece arranged in said mounting part;
a connector arranged in said passage opening;
a head clamping part;
a clamping mechanism cooperating with said head clamping part and said connector, said head clamping part and said clamping mechanism being movable in relation to one another to clamp said connecting piece to said mounting part; and
a positioning mechanism cooperating with said head clamping part, said clamping mechanism and said connector for positioning said connecting piece relative to said mounting part, wherein said positioning mechanism has a positioning mounting part which has a passage opening that is substantially congruent with said passage opening of said mounting part and has a spindle connected to said head clamping part, said head clamping part comprising a spindle nut, said clamping mechanism releasing and or locking said positioning mechanism upon clamping said connecting piece to said mounting part.

2. A safety device for locking an adjustable connecting piece in accordance with claim 1, wherein: said mounting part comprises a bracket shaped as a U-shaped part with legs, each of said legs defining said passage opening, said legs accommodating said connecting piece.

3. A safety device for locking an adjustable connecting piece in accordance with claim 1, wherein: said connector is a clamping pin with a pin end connected to said head clamping part and with said head clamping part, forming spindle nut, receiving said spindle.

4. A safety device for locking an adjustable connecting piece in accordance with claim 1, wherein: said elongated passage opening of said mounting part is an elongated hole formed elongated in a direction of adjustment.

5. A safety device for locking an adjustable connecting piece in accordance with claim 1, wherein: said clamping mechanism includes a lever.

6. A safety device for locking an adjustable connecting piece in accordance with claim 5, wherein: said clamping mechanism includes a thread, wherein said lever generates a stroke directed in an axial direction in relation to said connecting pieces during rotation around an axis of said connector and said stroke brings about clamping.

7. A safety device for locking an adjustable connecting piece in accordance with claim 1, wherein: said spindle is arranged in said head clamping part which defines said spindle nut; said mounting part of said positioning mechanism includes a yoke guiding and positioning said spindle axially and radially.

8. A safety device for locking an adjustable connecting piece in accordance with claim 7, wherein: a thread pitch of said spindle is selected to be such that self-locking is achieved because of the spindle pitch selected.

9. A safety device for locking an adjustable connecting piece in accordance with claim 3, wherein: said connecting piece is a jacket tube of a steering column of a motor vehicle with a welded-on U-shaped carrier, which has a through hole on each leg defining said passage opening for connection with said connector.

10. A safety locking arrangement comprising:
a mounting part defining at least one passage opening;
a connecting piece arranged inside said mounting part, said connecting piece being movably mounted in said mounting part in an adjusting direction;
a connector connected to said connecting piece;
a spindle nut connected to said connector;
a clamp mechanism connected to said connector, said clamping mechanism being movable in a clamping direction in relation to said spindle nut to clamp said connecting piece to said mounting part; and
a positioning mechanism including said spindle nut and including a spindle pin rotatably mounted in said spindle nut to adjust a position of said spindle nut in said adjusting direction with a longitudinal axis of said spindle pin being perpendicular to said clamping direction, whereby clamping of said clamping mechanism applies force to said spindle pin to block said spindle pin from rotating to lock a position of said spindle nut.

11. An arrangement in accordance with claim 10, wherein:
said clamping mechanism is movable outward and inward toward the mounting part in said clamping direction to selectively clamp and unclamp said connector with said mounting part, said clamping direction being different than said adjusting direction;
said connector comprises a clamping pin passing through said mounting part and said connecting piece;
said clamping pin is fixed to said connecting piece in said adjusting direction, said clamping pin is movable in the other of said first and connecting piece in said adjusting direction; and
at least one passage opening is an elongated hole in said adjusting direction, said clamping pin passing through said elongated hole.

12. An arrangement in accordance with claim 10, wherein:
said clamp mechanism includes a quick release lever mechanism and an adjusting nut for positioning said quick release lever mechanism, said quick release lever to selectively clamp and unclamp and also lock and unlock said positioning mechanism.

13. An arrangement in accordance with claim 10, wherein:
said positioning mechanism includes a yoke to receive said spindle pin and to prevent axial adjustment of the spindle.

14. An arrangement in accordance with claim 13, wherein:
said yoke includes two shanks for axially fixing a position of said spindle

15. An arrangement in accordance with claim 14, wherein:
each shank of said yoke has a wedge shaped surface contacting said spindle to block rotation of said spindle pin when said clamp mechanism applies force to said spindle pin.

16. An arrangement in accordance with claim 14, wherein:
said one passage opening is an elongate opening;
said yoke has an elongate opening corresponding to said passage opening; and
said connector passes through each of said elongate opening of said yoke and said passage opening.

17. An arrangement in accordance with claim 16, wherein: said elongate opening of said yoke is between said two shanks and said spindle nut is arranged between said two shanks.

18. An arrangement in accordance with claim 14, wherein said spindle nut is provided as a free end of said connector.

19. An arrangement in accordance with claim 10, wherein:
said mounting part comprises a U-shaped bracket having legs defining said passage opening;
said connecting piece is arranged between said legs; and
said legs are arranged between said spindle nut and said clamping mechanism.

20. An arrangement in accordance with claim 19, wherein:
said positioning mechanism includes a yoke to receive said spindle pin and to prevent axial adjustment of the spindle; and
said yoke is arranged outside said U-shaped part.

21. A safety locking arrangement comprising:
a mounting part defining at least one passage opening;
a connecting piece arranged inside said mounting part, said connecting piece being movably mounted in said mounting part in an adjusting direction;
a connector connected to said connecting piece and passing through said passage opening;
a spindle nut connected to said connector;
a clamp mechanism connected to said connector, said clamping mechanism being movable in a clamping direction in relation to said spindle nut to clamp said connecting piece to said mounting part; and
a positioning means including said spindle nut, a yoke and a spindle pin rotatably mounted in said spindle nut and guided and supported by surfaces of said yoke to adjust a position of said spindle nut along said spindle pin, said spindle pin being perpendicular to said clamping direction, whereby clamping of said clamping mechanism applies force to said spindle pin relative to said spindle nut and yoke surfaces to block said spindle pin from rotating to lock a position of said spindle nut along said spindle pin.

22. An arrangement in accordance with claim 21, wherein:
said spindle nut forms a free end of said connector;
said mounting part comprises a U-shaped bracket having legs defining said passage opening;
said connecting piece is arranged between said legs;
said legs are arranged between said spindle nut and said clamping mechanism;
said one passage opening is an elongate opening;
a longitudinal axis of said spindle pin is parallel to a direction of elongation of said elongated hole;
said yoke is arranged outside said U-shaped part;
said yoke has an elongate opening corresponding to said passage opening; and
said connector passes through each of said elongate opening of said yoke and said passage opening;
